(19) United States
(12) Patent Application Publication
(10) Pub. No.: US 2017/0190321 A1
(43) Pub. Date: Jul. 6, 2017

(54) VEHICLE-WASHING INSTALLATION, METHOD FOR CLEANING VEHICLES, AND CLEANING AGENT

(71) Applicant: WASHTEC HOLDING GMBH, Augsburg (DE)

(72) Inventors: Robert AUER, Stadtbergen (DE); Andreas SATTLER, München (DE)

(73) Assignee: WASHTEC HOLDING GMBH, Augsburg (DE)

(21) Appl. No.: 15/128,246

(22) PCT Filed: Mar. 13, 2015
(86) PCT No.: PCT/EP2015/055262

§ 371 Date: Feb. 6, 2017

(30) Foreign Application Priority Data
Mar. 26, 2014 (DE) 10 2014 104 238.7

(51) Int. Cl. B60S 3/04; B08B 3/02; B08B 1/00; C11D 3/04; C11D 17/00; C11D 3/22; C11D 3/00; B08B 7/00; B08B 7/04

(52) U.S. Cl. CPC B60S 3/04; B08B 7/0014; B08B 3/02; B08B 1/002; B08B 7/04; C11D 17/003; C11D 3/222; C11D 3/0026; C11D 3/046

(57) ABSTRACT

A vehicle-washing installation, a method for cleaning a vehicle, and a cleaning agent in the form of a system includes at least two components for use in such a method and vehicle-washing installation. The method is suitable for a vehicle-washing installation in which drying of the formed film is not required. A high-pressure water jet mechanically removes the film and eliminates the soiling of the vehicle surface. The system includes a component A, having at least one film-forming polymer in a substantially aqueous solution, and a component B, having at least one hardener in a substantially aqueous solution. The component A is applied to the vehicle at least once and then a solid or gel-like film is produced by applying component B at least once, which film is removed by pressurized post-cleaning fluid and/or washing brushes. The vehicle-washing installation includes an application device for applying the first and second components.

### FIELD OF THE INVENTION

The present invention relates to a vehicle washing installation as well as to a method for cleaning vehicles using a film-forming cleaning agent consisting of two components.

### BACKGROUND

When cleaning vehicles, in particular motor vehicles, in standard washing installations, the problem frequently occurs that during cleaning with a high pressure water jet, the surface still has a certain particle dust layer that causes the paint surface to appear dull. Despite the use of water that is applied under high pressure using high pressure spray devices either by machine or manually, and if necessary with the addition of detergents during a pre-treatment process, it is in many cases not possible to completely remove the adhering dirt particles. The insufficient result can be seen by the fact that a slightly matt film remains on the paint surface, which can for example be wiped off by touching and smears. This film may be found objectionable and should be removed, apart from aesthetic reasons, also for reasons of protecting the paint, because the particle film causes further dirt to accumulate and can therefore lead to long-term damage to the paint layer. The dirt particles are made up of minute particles of minerals or salts, to which partially soot particles, grease, organic substances of plant or animal origin and many other substances occurring in road dirt may be bound. The adherence of these particles has numerous causes. On the one hand, a usual adhesive force, as may occur for example as a result of electrostatic Coulomb forces, is to be taken into account. On the other hand, particles carry charges with different signs, they attract each other and therefore adhere to the surface like a film. Different charges may develop for example tribologically when the particles impinge on the body surface. Moreover, there is a certain prehistory, i.e. for example contact and friction might have resulted in charged particles even before the impact. Apart from electrostatic forces, also van-der-Waals forces may play a part, i.e. the dipole moments between the material of the particles and the surface of the vehicle may be such that attraction develops. Furthermore, the surface roughness is to be taken into consideration. Particles in the nanometre range and hydrophobic dirt may collect in the surface roughness for example as a result of van-der-Waals forces and may further accumulate particles of a similar nature.

For the reasons mentioned above there is a desire to remove the particles which have until now continued to adhere to the vehicle surface after a conventional vehicle washing operation. This operation should be carried out in a substantially contact-free manner, i.e. the use of mechanical cleaning devices such as brushes etc. is not required.

The use of a high pressure water jet as customary in vehicle washing installations by itself is not sufficient to completely remove the dirt particles. For this reason it has been contemplated to lift off the particles from the vehicle surface by means of some auxiliary object that overcompensates or cancels out the above-mentioned forces.

DE 27 22 390 A1 relates to a method for cleaning objects, in particular vinyl records and vinyl record matrices, wherein, if necessary, a liquid is applied, in particular sprayed, onto the surfaces to be cleaned with detergents after rinsing, which liquid transforms into a peelable film, and the dry film is then peeled off. The liquid for carrying out this process does not attack the object, it completely wets the surface thereof and has good flow properties without forming bubbles, and solidifies to form a film that can be peeled off from the surface without leaving residues under such conditions that do not cause any damage to the object to be cleaned, and during the peeling off, any dust particles and the like are picked up at the same time. The film consists of polyvinyl alcohol with an average molecular weight of 80,000, fatty acid and preferably triethylene glycol. This solution is brushed or sprayed onto the vinyl record to be cleaned, or the vinyl record is submersed in it. The film formed after the drying is subsequently peeled off, whilst the dirt particles are at the same time removed from the vinyl record grooves.

DE 29 19 886 A1 relates to a method for keeping clean inner and outer surfaces liable to get dirty, wherein a film former generates a protective layer, onto which dirt may deposit, and subsequently the latter is rinsed off, and this protective layer is to a certain extent preserved and renewed.

DE 14 80 412 A1 relates to a motor vehicle washing installation, wherein the vehicle passes through gantry-type racks with cloths that are suspended from the rack on all sides and are sprayed upon by spray nozzles.

Thus, DE 27 22 390 A1 provides a method, by means of which particles located on a surface are removed by means of a film that is applied, subsequently dried and finally mechanically peeled off. An essential condition for this is that the film on the object to be cleaned is dry. DE 29 19 886 A1 provides a surface with a layer that protects the object against soiling and picks up any dirt. The condition for this is that the layer is dried on the surface. Subsequently, the layer together with the dirt located thereon is removed. What both solutions have in common is that they constitute a one-component system. Whilst in DE 14 80 412 A1 the cloths lie flat on top of an area, during movement the dirt is dissolved but is displaced on the paint and can therefore cause scratches.

WO 96/40454 A1 relates to the contact-free cleaning of objects, wherein a cleaning solution is applied onto the object, until a film covers the surface. In the course of this, the film solidifies around the dirt particles, which are then released together with the film from the object by means of a water jet. In the course of this, the cleaning solution is mixed with a polymer using a mixing nozzle and is sprayed together therewith onto the object. What is of disadvantage is that the mixing nozzle may clog up and, due to the mixture thickening as early as immediately after the mixing, cannot ensure a comprehensive wetting of the object.

DE 23 20 925 C1 relates to a method and a device for spraying vehicles in a washing installation, wherein prior to the beginning of the washing operation, a cleaning agent containing solution is applied within a short time onto the vehicle, the vehicle is then washed and the solution is rinsed off, and only after the end of the washing and rinsing process, it is covered with a preserving liquid also within a short time. In the course of this, the solution or the liquid is applied, before the beginning or after the end of the washing or drying operation, initially onto one end of the vehicle and then over the vehicle up to the other end of the vehicle, in the manner of an irrigation operation.

### SUMMARY

The disclosure relates to a method suitable for a vehicle washing installation, in particular a gantry washing installation or a tunnel washing system, wherein no drying of the formed film is required, but the dirt is removed from the vehicle surface by mechanically releasing the film by means of a high pressure water jet. In at least some embodiments, the means used for carrying out the method should be based on water, should be available in a cost-effective manner and should also be ecologically compatible. Moreover, the cleaning agent should be suitable for being used in vehicle washing installations that are equipped with the usual standard components.

Preferred embodiments and advantageous developments of the invention are also disclosed.

The invention allows a condition to be achieved as a result of the application of a temporary film, wherein the force of the high pressure cleaning is sufficient in order to release any particles adhering as a result of forces, such as for example electrostatic Coulomb forces, van-der-Waals forces, a cohesive or adhesive bond with other contaminants such as oil and other hydrophobic substances, to the surface, wherein the particles adhering to the film are removed together therewith by means of a pressurised fluid, in particular water, if necessary also by means of washing brushes.

According to the invention, the vehicle washing installation is characterised in that an application device for applying a first component A, comprising at least one film-forming polymer in a substantially aqueous solution, and for applying a second component B, comprising at least one hardener in a substantially aqueous solution, is provided.

In the course of this, the application device may advantageously include a first application device for applying the at least one component A and/or a second application device for applying the at least one component B. Preferably, the first application device may be provided, in the washing direction, spatially upstream of the second application device. As a result, the two components A and B may be applied substantially at the same time, which is advantageous in particular in the case of gantry washing installations, because the application of the components can then be carried out in a time-saving manner in one passage of the washing gantry.

In a further embodiment of the invention, the application equipment may include a common application device for applying components A and B.

Furthermore, advantageously a device for removing the layer formed from components A and B using a post-cleaning fluid, in particular water, may be provided, which may advantageously be formed as a further application device.

Preferably, the application devices described above and below may be spray devices formed in one or more parts, having one or more spray nozzles.

In the method according to the invention for cleaning a vehicle with a system indicated below and consisting of a plurality of components, the first component A is applied onto the vehicle at least once, and subsequently a solid or gel-like film is generated as a result of the at least one application of component B, which film is finally removed using pressurised post-cleaning fluid and/or washing brushes.

Advantageously, the vehicle may be pre-cleaned prior to the application of the first component A with pre-cleaning fluid. For this, the pre-cleaning fluid and/or the post-cleaning fluid may be water.

Preferably, component B may be applied multiple times in succession, in order to ensure the generation of the film and in order to compensate for any thinning effects of component B or any component B that might flow off too quickly.

In order to shorten the time needed for a cleaning operation even further, components A and B may advantageously be applied substantially at the same time, but spatially spaced apart from each other, with component A being deposited spatially ahead. In particular, in the case of a gantry washing installation this brings about the advantage that as a result of this, the application of both components A and B is carried out in a single passage over the vehicle.

Component B may preferably be applied no earlier than 100 ms, preferably no earlier than 1 s and particularly preferably no earlier than 5 s after the application of component A, so that the cleaning duration is further reduced. Furthermore, component B may preferably be applied no more than 15 min, more preferably no more than 5 min and particularly preferably no more than 30 s after the application of component A, so that the cleaning duration is reduced even further.

After the application of component B, there may be a waiting time before the removal of the layer formed by components A and B of preferably at least 1 s and/or preferably no more than 30 min, preferably no more than 10 min, particularly preferably no more than 5 min, above all no more than 1 min and advantageously no more than 40 s. As a result, the cleaning duration may be reduced even further.

### BRIEF DESCRIPTION OF THE DRAWINGS

Further characteristics and advantages of the invention will result from the detailed description of the vehicle washing installation according to the invention, the method and the cleaning agent for cleaning the surface of a vehicle that will be given below using the following embodiment examples with reference to the drawings, wherein:

FIGS. 1a to 1f show a schematic lateral view of the paint surface of a vehicle to be cleaned during various steps of the cleaning process;

FIG. 2 shows the curve of the percentage weight reduction of a gel film shown in FIG. 1b as a result of drying;

FIG. 3 shows the curve of the percentage weight reduction of a layer shown in FIG. 1d;

FIGS. 4a to 4c show a schematic view of a vehicle washing installation according to the invention from the side (FIG. 4a), from the rear (FIG. 4b) and from the top (FIG. 4c), with separate application of the two components from the top and from the side;

FIGS. 5a to 5c show a schematic view of the vehicle washing installation according to the invention from FIG. 4 with a virtually simultaneous application of the two components from the top and from the side;

FIGS. 6a to 6c show a schematic view of the removal of the two components after application in the vehicle washing installation according to the invention according to FIG. 4 or 5 from the side (FIG. 6a), from the rear (FIG. 6b) and from the top (FIG. 6c).

### DETAILED DESCRIPTION

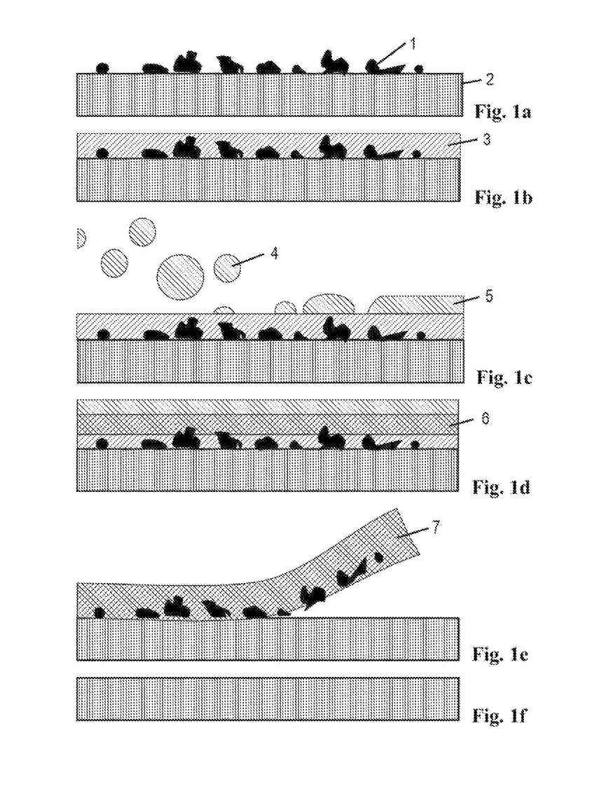

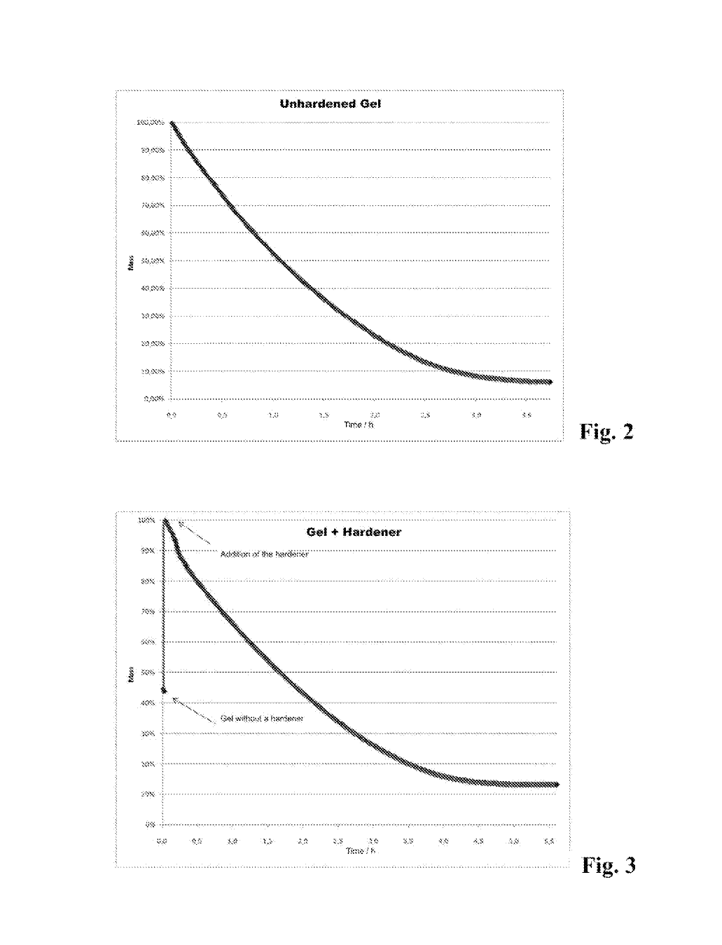

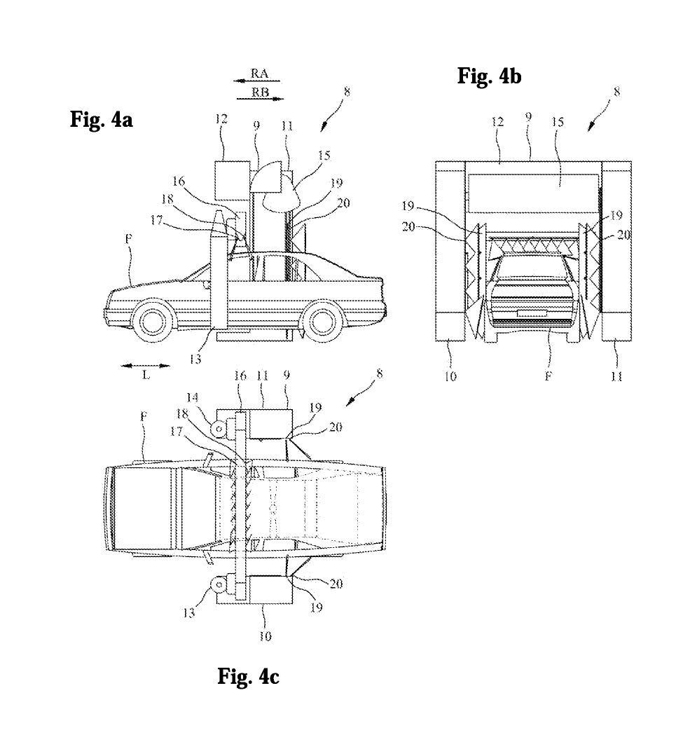

The operation according to the invention is schematically illustrated in FIG. 1. FIG. 1a shows the paint surface, with dirt particles 1 adhering thereto, of a vehicle F shown in FIG. 4 to 6. In the first step, shown in FIG. 1b, of the method according to the invention, component A, which comprises a film-forming polymer in a substantially aqueous solution, is applied at least once onto the surface 2 by injection or spray application. The injection application is in this case merely an example of the application of component A, also curtain or cast deposition, irrigation, rolling on or any other method suitable for gel-like liquids may be used. However, the applied gel layer must not be so thick that it no longer completely hardens in the subsequent method steps. Component A moreover has such an inherent viscosity that it remains on the surface as a film 3, cf. FIG. 1b. The applied gel film has a weight loss by drying at room temperature of approximately 10% within a quarter of an hour, cf. FIG. 2. This value may vary as a result of the selection of the substances used by 1 to 30 or 5 to 15%.

Subsequently, as illustrated in FIG. 1c, component B, cf. FIG. 1c, reference numeral 4, the so-called hardener, is applied at least once, preferably by spray application, within a period of time of at least 100 ms, preferably 100 ms to 15 min, more preferably 1 s to 5 min, particularly preferably 5 s to 30 s. Here, too, the further alternatives for an application method, which are mentioned in respect of the application of component A, may be used. From component B, layer 5 forms, which rests on layer 3 (component A). After the application, the formation of the hardened product of components A and B begins at the interface between layers 3 and 5 predominantly by diffusion, which is illustrated in FIG. 1d by layer 6. Depending on the rate of diffusion, full hardening is finally achieved. The period of time of the full hardening may be at least 1 s, preferably 1 s to 30 min, preferably 1 s to 10 min, particularly preferably 1 s to 5 min, above all 1 s to 1 min and further from 1 s to 40 s.

FIG. 3 illustrates the curve of the percentage weight decrease of such a layer. Although the layer is tear-resistant and film-like, however, it still includes solvents, substantially water, which is predominantly present in the above-mentioned processing period up to the state shown in FIG. 1d. Once full hardening has been achieved, layer 7 as illustrated in FIG. 1e is rinsed off from the surface 2 over the whole area using a high pressure water jet, so that finally the vehicle surface 2 remains freed from any dirt particles 1, as shown in FIG. 1f.

The method and the cleaning agent for cleaning the surface of a vehicle according to the present invention will be described in more detail below.

The vehicle washing installation 8 according to the invention as shown in FIGS. 4 to 6 is currently implemented as a gantry washing installation with a washing gantry 9 that can be traversed in a longitudinal direction L, having gantry columns 10, 11 and a gantry crossbeam 12 connecting the columns. Furthermore, vertical washing brushes 13, 14 and a horizontal washing brush 15 are provided, which in the figures are shown stationary without rotating. Furthermore, a rotatable roof dryer 16 is provided, which can be rotated in a manner per se known about a horizontal rotary axis extending transversely to the longitudinal direction L, so as to be directed, as frontal as possible, towards the surfaces extending transversely to the longitudinal direction, such as the front, the bonnet, the front and rear windscreens, the roof, the boot lid and the rear, so that the dry air jet impinges as optimally as possible. The washing gantry 9 traverses backwards and forwards one or more times for cleaning the vehicle F in the longitudinal direction L in a known manner. In the course of this, the washing direction extends parallel to the longitudinal direction L, as a function of the current direction of movement of the washing gantry 9, but in or against the longitudinal direction L. In the case of a tunnel washing system, however, in which the vehicle F is conveyed in the longitudinal direction L, the washing direction corresponds to the longitudinal direction.

Such a vehicle washing installation 8, which is for example equipped with frame spraying devices as application equipment, is principally known and can be used with the cleaning agent according to the invention. Examples of such vehicle washing installations are described in DE 16 30 276 A1, DE 195 30 27 A1, DE 20 45 048 A1, DE 23 20 925 C2 or DE 26 42 959 A1.

However, the invention can also be used with other vehicle washing installations, e.g. in the case of tunnel washing systems with forced conveying of the vehicle F, in brush washing installations or in pure high pressure vehicle washing installations or in combinations of all or several of such washing system types.

In general, in a first step, pre-cleaning of the vehicle F may as a rule be carried out using water or another pre-cleaning liquid. Here, the precleaning process begins as a rule at the front of the vehicle F, which means the washing gantry 9 traverses in FIGS. 4 to 6 (a) and (c) from the left to the right up to the rear of the vehicle F.

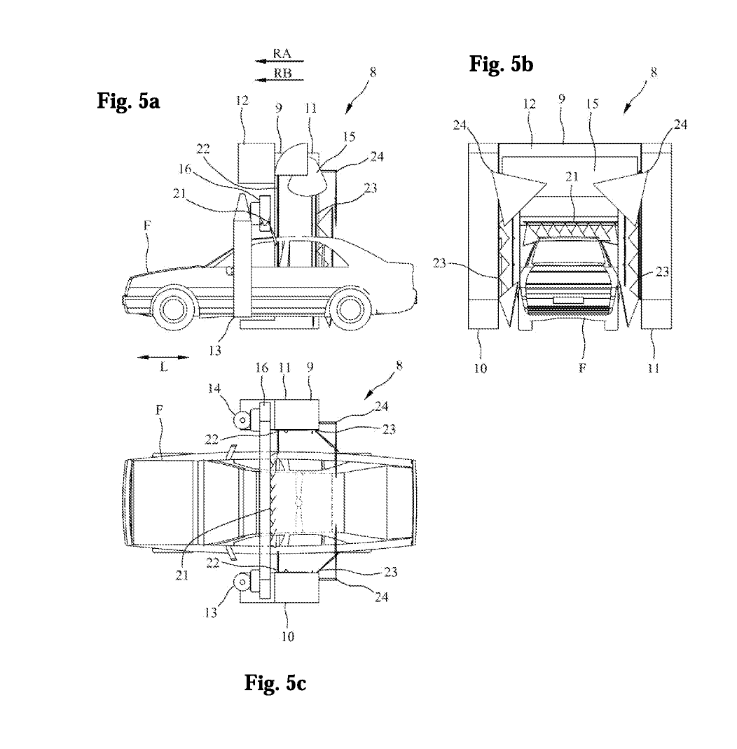

Subsequently, in the case of the cleaning processes shown in FIGS. 4 and 5, the cleaning begins at the rear of the vehicle F, i.e. in FIGS. 4, 5 (a) and (c) from the right, so that component A or both components A and B can be applied by passing from the rear towards the front.

In order to apply the two components A and B of the cleaning agent onto the vehicle F, in the embodiment shown in FIG. 4, two rows of spray devices having spray nozzles 17, 18 are provided on the roof dryer 16, wherein the spray nozzles 17, which are on the left in FIGS. 4 (a) and (c), spray the first component A and the right-hand spray nozzles 18 spray the second component B. Furthermore, the spraying device has rows of spray nozzles 19, 20 provided on the gantry columns 10, 11, with the spray nozzles 19, which are on the left in FIGS. 4 (a) and (c), spraying the first component A, and the right-hand spray nozzles 20 spraying the second component B. The spray nozzles 17, 19 form a first application device for the first component A, whilst the spray nozzles 18, 20 form a second application device for the second component B. Since in FIG. 4 (b) the “rear” spray nozzles 19 cannot be seen, the spray fan generated thereby is also designated with reference numeral 19. In FIG. 4 (c), the gantry crossbeam 12 has been omitted for reasons of clarity.

However, in the embodiment shown in FIG. 5, for the simultaneous application of component A onto all vehicle surfaces, a row of spray nozzles 21 is provided on the roof dryer 16 and on the gantry columns 10, 11 in close vicinity to the spray nozzles 21, further spray nozzles 22 are provided in order to ensure a preferable simultaneous, if not with just a slight delay, application of component A. However, for component B, on the one hand lateral spray nozzles 23 are provided, in FIGS. 5a and 5c, at the right-hand end of the gantry columns 10, 11, as well as spray nozzles 24 at the top of the gantry columns 10, 11, which again allow a substantially simultaneous application of component B. The spray nozzles 21, 22 form a first application device for the first component A, whereas spray nozzles 23, 24 form a second application device for the second component B.

After the optional pre-cleaning with water or another pre-cleaning liquid, in a second step, an aqueous solution of component A is sprayed using spray nozzles 17 and 19 or 21 and 22, respectively, onto the vehicle F, so that the vehicle surface is completely covered with a gel layer. The form of the product sprayed from the spray nozzles 17 and 19 or 21 and 22, respectively, is designed such that it is sufficient to completely cover the entire vehicle body all over with an aqueous solution of component A, e.g. with a spray cone.

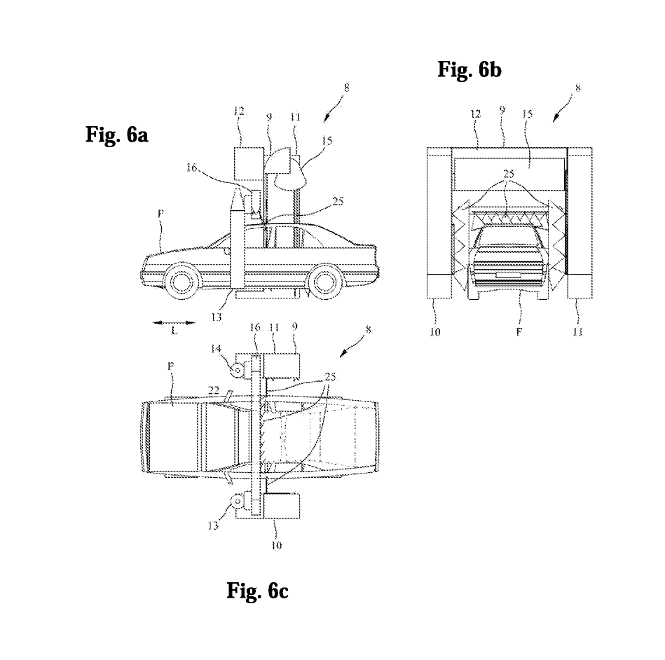

Component B is then applied using spray nozzles 18 and 20 or 23 and 24, respectively, over the entire surface onto the still wet gel film of component A. Here, too, the application is carried out largely over the entire surface area. Whilst in the current gantry washing installation 8 shown, the spray device(s) 17-24 move over the vehicle F or, in a continuous tunnel washing system, the vehicle F moves past the spray devices, a solid film 7 is formed on the body of vehicle F behind the spray nozzles 18 and 20 or 23 and 24, respectively, for the second component B. This solidified, but not completely dry film 7 is removed again from the vehicle surface with a high pressure jet known per se, using a further or, if necessary, the same spray device, preferably with one or more rotating spot jets or fan jets, as indicated in FIG. 6. Preferably, the removal by means of a high pressure jet 25 can also be supported by the use of washing brushes which are known per se.

In the embodiment shown in FIG. 4, in a first passage of the washing gantry 9 from the rear to the front of the vehicle F, component A is initially applied onto the vehicle F by means of the spray nozzles 17 and 19. Subsequently, the washing gantry 9 moves in the opposite direction from the front to the rear of the vehicle F and in doing so applies component B. The application directions of components A and B are identified with arrows RA and RB.

After the hardening of the gel layer 7 or the film 7 as described above and below, the latter is then preferably rinsed off over the entire surface area by means of a water jet 25, as shown in FIG. 6. For the spraying off, nozzles that are known per se, such as full cone nozzles, hollow cone nozzles, full jet nozzles, irrigation nozzles, two-substance nozzles, preferably also flat spray nozzles or moved point nozzles may be used. Instead of water, also other suitable fluids may be used.

In the embodiment shown in FIG. 4, instead of the process described above, initially, in a first passage of the washing gantry 9, the vehicle surfaces extending transversely to the longitudinal direction L may be sprayed with components A and B using the spray nozzles 17 and 18. After the hardening of the gel layer 7 as described above and below, the latter is then preferably rinsed off over the entire surface area in a separate passage by means of the water jet 25, as shown in FIG. 6 and described above. Subsequently, in a subsequent passage of the washing gantry 9, the lateral spray nozzles 19 and 20 are then again used to apply components A and B one after the other, and after that once more the hardened gel layer 7 as described above and below is removed from the vehicle F as described above. In principle, the order of the application may be reversed, i.e. initially components A and B are applied onto the lateral surface using the lateral spray nozzles 19 and 20, then the gel layer 7 is removed for the first time, subsequently the vehicle surfaces extending transversely to the longitudinal direction L are sprayed with components A and B using spray nozzles 17 and 18 and finally, the gel layer 7 newly formed as a result may be removed for a second time.

In the embodiment according to FIG. 5, however, components A and B may be applied during a single passage from the rear to the front of the vehicle F, since the spray nozzles 21 and 22 that move spatially ahead in the application direction RA spray component A virtually simultaneously onto all vehicle surfaces, and with a time delay, the spray nozzles 23 and 24 that follow behind in the application direction RB, spray component B virtually simultaneously onto the vehicle surfaces sprayed with component A. This embodiment has the advantage that only one instead of two passages of the washing gantry 9 is required in order to apply components A and B onto the vehicle F. Here, too, the gel layer 7 is removed by spraying off from the vehicle F after sufficient hardening as described above and shown in FIG. 6.

The cleaning as described above with the application of the two components A and B may also be carried out without any pre-cleaning, so that the cleaning is advantageously carried out from the front of the vehicle F, i.e. from the left in FIGS. 4 to 6 (a) and (c). In these cases, the spray nozzles for components A and B are exchanged, so that initially component A and subsequently component B is applied. The same applies if for the pre-cleaning two passages of the washing gantry 9 from the front to the rear and back to the front are carried out, so that the cleaning starts at the front of the vehicle F.

Component A has a gel-like character and should preferably be pH neutral or alkaline. An essential ingredient is an organic compound which, by adding a further component B in an aqueous environment, forms a solidified film. Unlike the films described in DE 27 22 390 A1 and DE 29 19 886 A1, this film formed from two components is solid, but not dry, cf. FIG. 3. Preferred as an organic substance are gel-forming organic polysaccharides, for example alginic acid and the water soluble salts thereof, carrageenan, xanthan, traganth, glucan or gelan as well as mixtures thereof. Preferred are the water soluble salts of alginic acid, in particular ammonium alginate, magnesium alginate, sodium alginate and/or potassium alginate and/or mixtures thereof. Apart from these naturally occurring polysaccharides, also polymers are conceivable as film formers and/or as additive for component A, such as polyacrylates, polycarboxylates (in particular on the basis of acrylic acid, methacrylic acid or maleic acid), modified polycarboxylates (in particular on the basis of acrylic acid, methacrylic acid or maleic acid), or polyalcohols, in particular polyvinyl alcohols (PVA), polyglycols, polyvinylpyrrolidone as well as mixtures of the above-mentioned film formers with a suitable structure and, if necessary, a suitable crosslinker. Commercial polymers in this sense are products of BASF company, for example those of the Sokalan® series, e.g. Sokalan CP, DCS, HP, IR or PA, products of the Rheovis® series, e.g. Rheovis CDE, CSP, FRC, AT 120 or TTA, products of the Lupasol® series, e.g. Lupasol FG, G, HF, P, PR, PN, PO, PS, SK, VT or WF, products of the Euperlan® series, e.g. Euperlan HCO or PO/N, products of the Polyquart® series, e.g. Polyquart Ampho 149, PRO A, Ecoclean, FDI or SD09, products of the Soilfix® series, e.g. Soilfix IR, and products of the Tamol® series, e.g. Tamol NH, NN, DN or PP. These products may also be used in a mixture. For ecological reasons, the naturally occurring polysaccharides, in particular alginates, are preferred. It is of advantage if component A contains at least one surfactant and/or at least one defoamer.

Alginic acid is a natural substance. It is obtained predominantly from brown algae. In Europe, alginic acid is obtained in large quantities from Laminaria algae of the North Sea. Moreover, alginic acid is a cost-effective raw material. It is composed of L-guluronic acid and D-mannuronic acid. The average molecular weight may be in a range of approximately 30,000 to approximately 300,000. Although alginic acid is substantially insoluble in water, its salts (alginates) with alkaline metals are soluble in water. What is known are sodium and potassium alginate. These are used, inter alia, in the food industry. However, ammonium alginate is also soluble in water. Aqueous sodium alginate solutions with a proportion of more than 4% are as a rule too viscous for spray processing. Commercial alginates are available in a plurality of viscosity types, with high viscosity, medium and low viscosity. The types are classified by their origin, e.g. whether the alginate was obtained from the stem or the leaves of the algae, and what is also of importance is the type of algae used, e.g. Laminaria hyperborea, Laminaria nignenscens, Laminaria trabeculata, Durvillaea Antarctica, Laminaria digitata, Ecklonia maxima, Macrocystis pyrifera, Ascophyllum nodosum or Laminaria japonica. Depending on the type, concentrations of 3.0% of alginate may have a viscosity of 10,000, 24,000 or 38,000 mPas, concentrations of 2.0% may have a viscosity of 3,000, 6,000 or 11,000 mPas, and concentrations of 1.5% may have a viscosity of 1,000, 3,000 or 5,000 mPas. The viscosity of the alginate solution is a function of the temperature and decreases with increasing solution temperature.

Alginate gel may be understood to be a partially solid and partially liquid solution. Water and other molecules are physically included in the alginate matrix by capillary forces. However, depending on their size, the enclosed molecules remain capable of migrating and diffusing. For this reason, alginates may absorb, enclose and/or encapsulate further substances.

Alginates are soluble in cold water and do not need to be heated and then cooled for forming gels, as this is the case with some other biopolymers (e.g. traganth, carrageen, agarose, xanthan, gelan, glucan etc.). Should other biopolymers be used, a mixture with alginate is of advantage. The gels may be adjusted in such a way that various properties are achieved, such as hard and brittle to soft and supple. Preferred is an aqueous, semi-solid film of alginate gel that clings to the surface.

The polymer of component A, here the alginate, is indispensable for the functioning of the gel in the film forming process. Gels with a very low content of alginate harden so as to be no longer usable. The cleaning performance increases in line with the increasing alginate content. Due to the strong thickening properties of the alginates, gels with a very high alginate content are difficult to handle in the process. For this reason, an alginate content of 0.05 to 10%, preferably 0.5 to 8%, particularly preferably 1 to 4%, depending on the polymer type used, should be applied. For sodium alginate, an amount of 1 to 4% is preferred. For other polymers, these content figures may be 1 to 50% higher or lower. The percentages provided in the description are related to weight, unless otherwise stated.

The viscosity of the gel of component A varies, as explained above, to a large degree with the alginate content and the origin of the alginate. Other polymers have a substantially lesser effect. The viscosity of an alginate gel can, if necessary, be reduced by adding further polymers. Solvents may increase the viscosity of the gel, provided they are easily soluble in water. For processing reasons, it is desirable for the viscosity of the gel to be as low as possible prior to the hardening. The reasons for this are the requirements that the gel should wet the surface and the dirt particles as well as possible, that it should rapidly spread over the surface and that spray application should be possible. This is in competition with the observed enhanced cleaning off as a result of a high alginate content, so that by adjusting the respective constituents of component A, an optimum should be determined in any case. For example, a gel with a low alginate content has as a rule viscosities between 100 and 1,000 mPas. Application is possible here in a technically simple manner—however, the cleaning performance is lower than in the case of a higher alginate content. In the case of a higher alginate content, the viscosity indeed increases drastically and reaches values that are comparable with those of pastes, emulsion paints or the like. Application is then possible only with special equipment (e.g. a spray gun with a pressurised cup). However, the cleaning performance is higher. In particular gels of component A with a high alginate content additionally have a pronounced shear liquefaction or shear thinning. This might be the reason for the fact that it can be spray-applied despite its high viscosity.

Component B (hardener) is an aqueous solution of a substance that forms a solid film with a gel layer of component A. Component B as a hardener may be a water-soluble salt of a polyvalent cation, an aqueous acid and/or a water-soluble solvent. Polyvalent metal salts, which may form a water-insoluble film with component A, are preferably selected from calcium, strontium, barium, iron(II) or (III), zinc or aluminium salts or any mixtures thereof. In particular, in the case of biopolymers, aqueous solutions of calcium salts, such as calcium chloride, calcium nitrate or calcium lactate or corresponding aluminium salts are suitable. Equivalent strontium or barium salts may also be used, however, they have disadvantages compared to calcium salts or aluminium salts, e.g. higher costs or poorer environmental compatibility. Calcium salts form solid films above all with alginate or with carrageen. Calcium ions cross-link the dissolved polymers with each other to form higher aggregates that finally form solid bodies. These solid films enclose dirt particles or bind them through other physical phenomena. PVA and other polyhydroxides also cross-link with borate.

A concentration of at least 30 mmol/l (Ca2+) should be present in the hardener, in order to achieve a marked hardening. For an effective hardening, at least 50 mmol/l are necessary. Higher concentrations are of advantage in any case. Only easily soluble Ca2+ salts have a hardening effect on the film. Ca(NO3)2 and CaCl2 as well as saline solutions produced by dissolving CaCO3 in acids (H3PO4 and HCl) have proven to be useful.

Alternatively, the sodium alginate film also hardens as a result of an acid effect (acid as the hardener). In principle, any desired acid may be used for this that is capable of precipitating the alginic acid. A pH value of no more than 3 is necessary in order to achieve an effective hardening. As a rule, more acidic hardeners are more effective than weak acids. The maximum possible concentration/effect of an acidic hardener is limited by the surrounding conditions (economy, corrosion, regulations on hazardous substances etc.). What takes place is essentially an acid displacement, and the alginic acid that is substantially less readily soluble in water forms a film. Contemplated for use are mineral acids such as phosphoric acid or hydrochloric acid, however preferred are biologically compatible and odour-free organic acids such as citric acid, sulfonic acid or gluconic acid, of which environmentally compatible substances such as citric acid or gluconic acid are preferred.

A film hardening effect may also be evoked by spraying water-soluble solvents such as ethanol onto the sodium alginate film. In this case, the ethanol extracts water from the gel film and causes solidification. By itself, a hardening of the gel with solvents is not very promising. The addition of 5 to 10% of solvent to a hardener, however, may be beneficial for its effect but is not absolutely necessary. The use of ethanol and isopropanol has proven to be effective.

The viscosity of component B is regularly low (approximately comparable with that of water). Solvents have a slight thinning effect, other ingredients have a slight thickening effect. In the case of the targeted concentrations (component B in application concentration), both effects are low.

The hardener may be formulated for its final use as a concentrate and may be diluted prior to application.

After mixing component A with component B, a hardened film is formed which, unlike components A and B, no longer constitutes a fluid. The hardened gel additionally has film coherence, tensile strength etc., i.e. the film formed is broadly comparable for example with paints, adhesives, elastomers, etc.

Alginate in component A offers a multiplicity of gel forming opportunities, of which the most popular is diffusion hardening. In diffusion hardening, an alginate solution—e.g. applied onto a surface—is sprayed with a calcium salt solution at a neutral pH value. The calcium ions diffuse into the solution and form a calcium-alginate gel. The rate of diffusion may be increased by increasing the calcium concentration or by using a particularly calcium-reactive alginate, such as an alginate with a particularly high proportion of guluronic acid blocks. The diffusion system may also be triggered by a pH reduction (acid) or by dehydration (dehydrating solvent such as ethanol).

Both component A and component B may contain additives.

In order to assist dirt removal, component A may be mixed with a cleaning polymer. Preferably, a cleaning polymer on the basis of acrylate in an amount of 0.05 to 10%, preferably in an amount of 0.1 to 8%, particularly preferably in an amount of 0.5 to 5% is used.

In order to adjust the rheological properties of component A, excipients may be added. Apart from the above-mentioned biopolymers, also polyacrylates, polycarboxylic acid polymers, polyvinyl alcohol (PVA), cellulose derivatives or the like may be used for this purpose. Preferred is an addition of PVA in a concentration of 3%. Apart from water as the main solvent, also a solubility promoting co-solvent may be used. By adding a co-solvent, also a viscosity and coalescence of the gel film may be modified. Preferred co-solvents are glycol ethers, in particular propylene glycol ethers, for example those of the DOWANOL series.

For stabilising the solution of component A and for an improved spreading ability on the car body paint, surfactants may be added to component A as a crosslinking agent. Surfactants may be used in an amount of 0.1 to 10%, preferably in an amount of 0.1 to 1%. For example, the surfactants are silicone surfactants. Since the gel film of component A should be applied in a manner as smooth and bubble-free as possible, defoaming agents are a useful addition. Defoaming agents for this purpose are preferably used in an amount of 0.1 to 2%. In this context it should be noted that the surfactants are not only used as a crosslinking agent, but also for enhancing the cleaning effect. In case surfactants are added in order to support cleaning, higher concentrations may be prudent.

Further useful additives are colourings, preservatives and scents, which may be added in an amount of less than 1%. As preservatives, sorbic acid, potassium sorbate, benzoic acid, sodium benzoate or esters of hydroxylbenzoic acid may be used.

All hardeners, i.e. component B, additionally contain a surfactant in a small amount (e.g. 0.005 to 1%, preferably 0.01 to 0.8%, particularly preferably 0.1 to 0.5%) as a crosslinking agent. The hardener may also be formulated as a concentrate.

Once components A and B, which must be fluids (albeit maybe highly viscous), have been successively applied onto the vehicle body, a film hardens after a short period of time. In the vehicle washing installation, the hardened gel may ideally be removed with splash water but certainly with a high pressure flat jet. However, the hardened film must no longer be liquid; it will usually be a clearly viscoelastic solid body. The basis for the hardening is, as explained above, a chemical or physico-chemical reaction of component A with component B. After an initial breaking up of the gel, an effective removal process is a peeling off of the film by the water jet. However, if the adhesion of the gel in the hardened condition is still too high, it can no longer be completely removed. This may occur for example due to problematic ingredients in the gel or due to insufficient hardening. Such a gel cannot be removed as a film. It breaks up within the film (not between the film and the surface), so that a thin layer remains on the substrate to be cleaned. For this reason, such behaviour has to be eliminated by way of a suitable adjustment of components and application times.

### Examples

A typical gel for cleaning tasks (component A) is provided below.

| Ingredient | Amount | Function |
|---|---|---|
| Sodium alginate | 1-4% | Hardenability |
| Cleaning polymer | 0-5% | Support dirt removal |
| Further polymers | 0-3% | If necessary, modification of |
| | | film properties and rheology |
| Solvent | 0-5% | Co-solvent. If necessary, |
| | | modification of viscosity and |
| | | coalescence |
| Water | 80-95% | Solvent |
| Silicone | 0.1-1% | Crosslinking agent |
| surfactant | | |
| Silicone defoamer | 0.1-2% | Defoamer |
| Colorant(s) | <1% | |
| Preservative(s) | <1% | |
| Scent(s) | <1% | |

During the release process it is important that the water is strongly stirred, whilst the alginate powder is being added. It may take 5 to 20 minutes until complete hydration has been reached. Pre-mixing with other substances may disturb the dissolution process, e.g. the addition of VOC, in particular ethanol or PEG or other substances. Any required additions as described above therefore should be matched to this behaviour. For this reason, the amounts are indicated as variable in the present example, because the specific value is a function of the properties of the alginate used. The product is formulated as a ready-for-use product.

For hardening, a 50 mmol/l calcium chloride solution with a surfactant additive is used.

### LIST OF REFERENCE NUMERALS

1 Dirt particles
2 Vehicle surface
3 Layer of component A
4 Component B (hardener)
5 Layer of component B
6 Layer formation of components A and B
7 Fully hardened layer or film of components A and B
8 Vehicle washing installation
9 Traversable washing gantry
10, 11 Gantry columns
12 Gantry crossbeam
13, 14 Vertical washing brushes
15 Horizontal washing brush
16 Rotatable roof dryer
17 Top spray nozzles for component A
18 Top spray nozzles for component B
19 Lateral spray nozzles for component A
20 Lateral spray nozzles for component B
21 Top spray nozzles for component A
22 Lateral spray nozzles for component A
23 Lateral spray nozzles for component B
24 Top spray nozzles for component B
25 Water jet
L Longitudinal direction
F Vehicle
RA Application direction component A
RB Application direction component B

1. A vehicle washing installation for cleaning a vehicle, wherein application equipment is provided for applying a first component A, comprising at least one film-forming polymer in a substantially aqueous solution, and for applying a second component B, comprising at least one hardener in a substantially aqueous solution.

2. The vehicle washing installation of claim 1, wherein the application equipment includes a first application device for applying the first component A.

3. The vehicle washing installation of claim 2, wherein the application equipment includes a second application device for applying the second component B.

4. The vehicle washing installation of claim 3, wherein the first application device is disposed in the washing direction spatially upstream of the second application device.

5. The vehicle washing installation of claim 1, wherein the application equipment includes a common application device for applying components A and B.

6. The vehicle washing installation of claim 1, wherein the vehicle washing installation includes a removal device for removing a layer formed by components A and B using a post-cleaning fluid.

7. A method for cleaning a vehicle comprising:
providing a cleaning system that includes a first component A, comprising at least one film-forming polymer in a substantially aqueous solution; and a second component B, comprising at least one hardener in a substantially aqueous solution;
applying the first component A at least once onto the vehicle; and
applying the second component B at least once to generate a solid or gel-like film;
removing the generated film using pressurised post-cleaning fluid and/or washing brushes.

8. The method of claim 7, wherein the vehicle is pre-cleaned with pre-cleaning fluid prior to the application of the first component A.

9. The method of claim 7, wherein the pre-cleaning fluid and/or the post-cleaning fluid is water.

10. The method of claim 7, wherein component B is applied several times in succession.

11. The method of claim 7, wherein components A and B are applied substantially at the same time, but spatially offset from each other, with component A being applied spatially ahead.

12. The method of claim 7, wherein component B is preferably applied no earlier than 100 ms, preferably no earlier than 1 s and particularly preferably no earlier than 5 s after the application of component A.

13. The method of claim 7, wherein component B is preferably applied no more than 15 min, preferably no more than 5 min and particularly preferably no more than 30 s after the application of component A.

14. The method of claim 7, wherein there is a waiting time of preferably at least 1 s after the application of component B before the film formed from components A and B is removed.

15. The method of claim 7, wherein after the application of component B, a waiting time of preferably no more than 30 min, preferably no more than 10 min, particularly preferably no more than 5 min, above all no more than 1 min and advantageously no more than 40 s is applied before the film formed from components A and B is removed.

16. A system of at least two components for use in a method for cleaning vehicles in a vehicle washing installation, the system comprising:
a component A, comprising at least one film-forming polymer in a substantially aqueous solution, and
a component B, comprising at least one hardener in a substantially aqueous solution.

17. The system of claim 16, wherein in component A, the at least one film-forming polymer is selected from polysaccharides, modified polysaccharides, polycarboxylates (in particular on the basis of acrylic acid, methacrylic acid or maleic acid), modified polycarboxylates (in particular on the basis of acrylic acid, methacrylic acid or maleic acid), polyalcohols (in particular polyvinyl alcohol), polyglycols, polyvinylpyrrolidone and mixtures as well as copolymers thereof.

18. The system of claim 17, wherein component A comprises ammonium alginate, magnesium alginate, sodium alginate and/or potassium alginate and/or mixtures thereof.

19. The system of claim 16, wherein component B comprises a substance as the at least one hardener, which is selected from the group consisting of a water-soluble salt of a polyvalent cation, an acid, a water-soluble salt and mixtures thereof.

20. The system of claim 19, wherein a calcium salt, in particular calcium nitrate, calcium chloride, calcium lactate or mixtures thereof is used.

21. The system of claim 16, wherein component A contains at least one surfactant and/or at least one defoamer.
